(19) United States
(12) Patent Application Publication
(10) Pub. No.: US 2015/0058425 A1
(43) Pub. Date: Feb. 26, 2015

(54) SMART MEETING SERVICE

(71) Applicants: Eyal Nathan, Reut (IL); Yotam Kadishay, Adanim (IL); Dvir Cooper, Ashkelon (IL)

(72) Inventors: Eyal Nathan, Reut (IL); Yotam Kadishay, Adanim (IL); Dvir Cooper, Ashkelon (IL)

(21) Appl. No.: 13/970,977

(22) Filed: Aug. 20, 2013

(51) Int. Cl. H04L 29/06; H04L 12/58

(52) U.S. Cl. CPC H04L 65/403; H04L 51/00
USPC 709/206

(57) ABSTRACT

The present disclosure describes methods, systems, and computer program products for providing a smart meeting service for setting up and managing meetings. One computer-implemented method includes receiving a meeting title as part of an indication to schedule a meeting; receiving an indication to engage a smart meeting service; receiving a content selection, a people selection, a time selection, and a location selection; sending a generated meeting request; and monitoring a meeting workflow for the generated meeting request.

### BACKGROUND

Calendar applications can allow a meeting organizer to set up a meeting for various meeting participants. For example, the meeting can be a design meeting for a software project, and the participants invited to the meeting can include people who are members of the project or are invited for other reasons (e.g., customers). Some participants can be key participants, meaning that their attendance at the meeting is required or at least highly recommended.

Meetings can occur at different times and at different locations, such as in particular meeting rooms. For example, some potential meeting locations may be close to some of the invited participants. In some instances, designated meeting locations may be established for meeting purposes. Different meeting locations may have different resources (e.g., conferencing equipment) that are capable of satisfying the needs of certain types of meetings.

Meetings can be related to different concepts or subjects, some of which may be business-related. For example, the meeting organizer may want to include attachments or other information in an email that invites attendees to the meeting.

### SUMMARY

The present disclosure relates to computer-implemented methods, computer-readable media, and computer systems providing a smart meeting service for setting up and managing meetings. One computer-implemented method includes receiving a meeting title as part of an indication to schedule a meeting; receiving an indication to engage a smart meeting service; receiving a content selection, a people selection, a time selection, and a location selection; sending a generated meeting request; and monitoring a meeting workflow for the generated meeting request.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the method further comprises initiating a presentation of a smart meeting wizard responsive to receiving the indication to engage the smart meeting service.

A second aspect, combinable with any of the previous aspects, wherein monitoring the meeting workflow further comprises determining whether an identified key person has accepted the meeting request.

A third aspect, combinable with any of the previous aspects, wherein the method further comprises initiating display of one or more context suggestions, one or more people suggestions, one or more time suggestions, and one or more location suggestions.

A fourth aspect, combinable with any of the previous aspects, wherein initiating a display of one or more people suggestions further comprises determining whether at least one of the people is considered a key participant in the meeting.

A fifth aspect, combinable with any of the previous aspects, wherein at least one of the one or more context suggestions, the one or more people suggestions, the one or more time suggestions, and the one or more location suggestions is determined, at least in part, using a usage history of a user scheduling the meeting.

A sixth aspect, combinable with any of the previous aspects, wherein the method further comprises initiating generation of a notification associated with meeting workflow issues.

A seventh aspect, combinable with any of the previous aspects, wherein the notification is a notification to a creator of the meeting that a particular key participant has declined or has not accepted the meeting request or that an attendance ratio for the meeting is below a predetermined threshold

The subject matter described in this specification can be implemented in particular implementations so as to realize one or more of the following advantages. First, meeting organizers can set up meetings more efficiently. For example, meeting organizers can select from automatically provided suggestions for meeting participants, meeting times, meeting locations, and content to be included with a meeting announcement. Second, applications used for scheduling meetings can automatically access information from other systems and sources, including project management systems, human resource systems, personal contacts, address books, mailing lists, and other sources. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for providing a smart meeting service according to an implementation.

FIG. 2 is a flow chart illustrating an example method for providing a smart meeting service according to an implementation.

Like reference numbers and designations in the various drawings indicate like elements.

### DETAILED DESCRIPTION

This disclosure generally describes computer-implemented methods, computer-program products, and systems for providing a smart meeting service for setting up and managing meetings. The system suggests relevant people, related documents, and other related materials for the meeting, and organizes the workflow before, during and after the meeting. Some or all of the system can be integrated with a mail client, a calendar application, and/or other systems. This can allow meeting organizers and/or other users to enhance and manage meetings in at least three aspects: people, content, and workflow. In some implementations, the system can include client and server components. The client component can be embedded in a mail application (e.g., as a plugin). The server component can provide the necessary information and suggestions to one or more clients, which can be different type of devices.

Capabilities of the system can include making suggestions based on a meeting title and description, identifying key participants, and managing the workflow once the meeting has been defined and a meeting request transmitted to potential meeting participants. The suggestions, for example, can be provided in a user interface used by a meeting organizer. The same or another user interface can be used to display identified key participants and to allow the meeting organizer to manage the meeting. Managing the workflow can also include providing information to other users who are participants in the meeting, e.g., including meeting-related email messages before and after the scheduled meeting.

Suggestions used in setting up a meeting can include suggestions of related people, content, meeting times, and meeting locations. Suggested related people, for example, can include people working on related projects, people that attended previous meetings on similar/related topics, key persons in the organizer's unit that are required in meetings of that type (e.g., system architect and performance engineer in design review meeting). In some implementations, suggesting related people can be achieved by connecting to various data sources, e.g., project management systems, human resource systems, personal contacts, address books, mailing lists, and other sources. Suggested meeting participants can also be determined from past meeting participants of other meetings of the same type, subject, description, and/or other meeting aspects.

Suggested related content can include documents, web pages (e.g., wikis, forums, intranet and Internet sites, etc.), business applications such as business systems, reports, and other content. In some implementations, the matching of related content can occur using semantic analysis algorithms, according to the meeting topic (e.g., based on the title and description of the meeting).

Suggested meeting times can include times that are suggested according to availability and time zones of the participants. For example, higher priority can be assigned to suggested times that are within the available schedule of key participants of the meeting.

Suggested meeting locations can include, for example, room suggestions for all relevant locations that are near invited meeting participants and that are appropriate for the given meeting type. For example, if the type of the meeting is a demo meeting, then the suggested meeting locations can include rooms that can video conference and/or other demo capabilities. In some implementations, designated meeting rooms are given a higher priority than other non-designated, relevant locations.

The system can identify key participants of the meeting, e.g., by allowing the meeting organizer to identify the key participants manually or by using the suggestion mechanism. For the purposes of this disclosure, key participants are the most important people in the meeting, e.g., including the decision makers, members of management, technical experts, and other key people. Identified key participants can be used in making suggestions, including meeting time suggestions, so as to facilitate as many key participants as possible.

The system allows for creating and managing a workflow associated with the meeting, e.g., with a goal of workflow including making the meeting more effective. For example, this is done by monitoring meeting participant replies and alerting the meeting organizer when key participants cannot attend (or acceptance rates are too low), verifying that a meeting summary is sent to participants after a meeting, and scheduling required follow-up meetings.

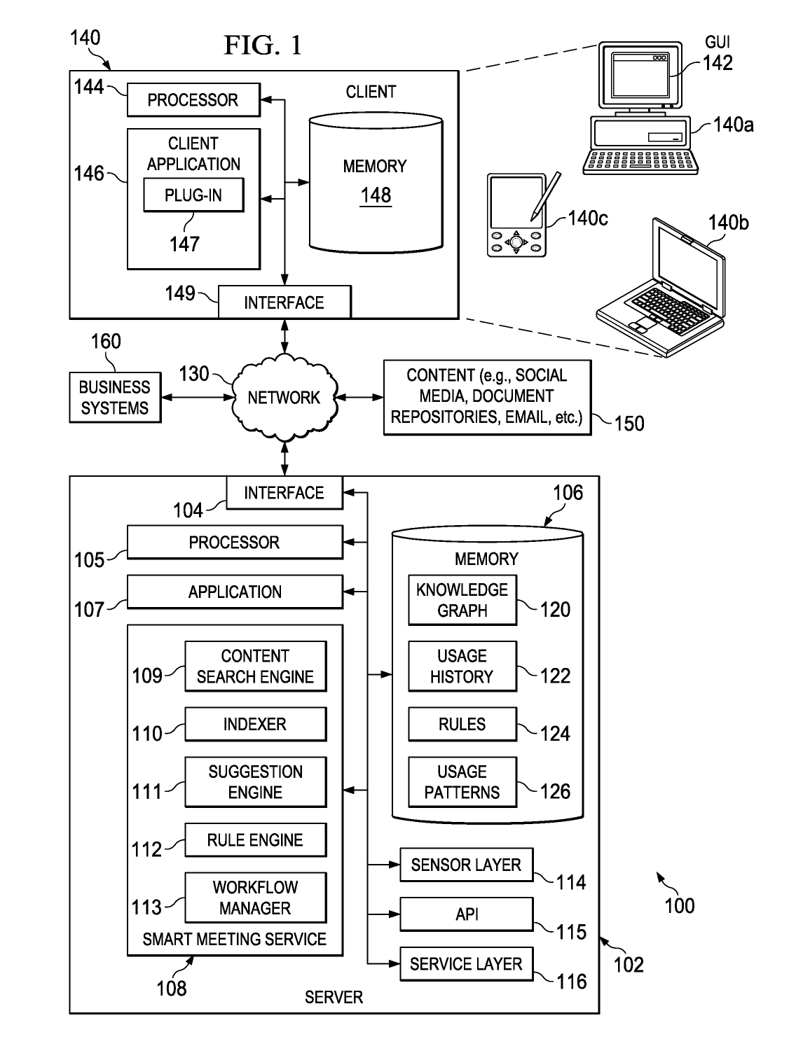

FIG. 1 is a block diagram illustrating an example meeting system 100 for providing a smart meeting service. The illustrated meeting system 100 includes, or is communicably coupled with, a server 102, at least one client 140, content 150 and business systems 160 that communicate across a network 130. At a high level, the server 102 is an electronic computing device operable to receive, transmit, process, store, or manage data and information associated meetings within the meeting system 100. According to some implementations, the server 102 may also include or be communicably coupled with other servers including, for example, e-mail servers, web servers, a caching server, a streaming data server, business intelligence (BI) servers, and/or other suitable servers. The following described computer-implemented methods, computer-readable media, computer systems, and components of the example meeting system 100.

In general, the server 102 is a server that provides access to information used to set up and manage meetings. The server 102 can also interact with user requests/responses sent by clients 140 within and communicably coupled to the illustrated meeting system 100. In some implementations, the server 102 can receive content 150 for use in suggesting content for meetings that are created on the client 140. In some implementations, the server 102 can receive information from business systems 160, e.g., human resource systems, customer relationship management (CRM) systems, supplier management systems, project management systems, and other systems that include information that can be used in making suggestions for meetings.

The server 102 is responsible for receiving requests using the network 130, for example, requests from one or more client applications 146 associated with the client 140 of the meeting system 100 and responding to the received requests by processing said requests in the one or more of applications 107 and a smart meeting service (SMS) 108. In addition to requests from the client 140, requests may also be sent to the server 102 from internal users, external or third-parties, other automated applications, as well as any other appropriate entities, individuals, systems, or computers.

In some implementations, some or all components of the server 102, both hardware and/or software, may interface with each other and/or the interface using a sensor layer 114, an application programming interface (API) 115 and/or a service layer 116. The sensor layer 114, for example, can sense or detect a current context of a user who is using the client 140. For example, the sensor layer 114 can analyze the user's usage history 122 in conjunction with what the user is currently doing on the client 140. The sensor layer 114 can also determine the projects to which the user is assigned and identify other people who are members of that project and/or who interact with the user. The information can be determined, for example, from the user's mailbox, e.g., to determine other people that the user has recently met. For example, the service layer 116 can analyze the topic and/or description of the meeting and determine one or more subjects to which the meeting is likely related.

The API 115 may include specifications for routines, data structures, and object classes. The API 115 may be either computer-language independent or dependent and refer to a complete interface, a single function, or even a set of APIs.

The service layer 116 provides software services to the meeting system 100. The functionality of the server 102 may be accessible for all service consumers using this service layer. Software services, such as those provided by the service layer 116, provide reusable, defined business functionalities through a defined interface. For example, the interface may be software written in JAVA, C++, or other suitable language providing data in extensible markup language (XML) format or other suitable format.

While illustrated as an integrated component of the server 102 in the meeting system 100, alternative implementations may illustrate the sensor layer 114, the API 115 and/or the service layer 116 as stand-alone components in relation to other components of the meeting system 100. Moreover, any or all parts of the sensor layer 114, the API 115 and/or the service layer 116 may be implemented as child or sub-modules of another software module, enterprise application, or hardware module without departing from the scope of this disclosure. For example, the API 115 could be integrated into the application 107 and/or the SMS 108.

The server 102 includes an interface 104 that is used by the server 102 for communicating with other systems in a distributed environment—including within the meeting system 100—connected to the network 130. For example, the interface 104 can be used by the client 140 as well as other systems communicably coupled to the network 130. Although illustrated as a single interface 104 in FIG. 1, two or more interfaces 104 may be used according to particular needs, desires, or particular implementations of the meeting system 100. Generally, the interface 104 comprises logic encoded in software and/or hardware in a suitable combination and operable to communicate with the network 130. More specifically, the interface 104 may comprise software supporting one or more communication protocols associated with communications such that the network 130 or the interface's hardware is operable to communicate physical signals within and outside of the illustrated meeting system 100.

The server 102 includes a processor 105. Although illustrated as a single processor 105 in FIG. 1, two or more processors may be used according to particular needs, desires, or particular implementations of the meeting system 100. Generally, the processor 105 executes instructions and manipulates data to perform the operations of the server 102. Specifically, the processor 105 executes the functionality required to provide meeting set-up, definition and workflow management.

The server 102 also includes a memory 106 that holds data for the server 102, client 140, and/or other components of the meeting system 100. Although illustrated as a single memory 106 in FIG. 1, two or more memories may be used according to particular needs, desires, or particular implementations of the meeting system 100. While memory 106 is illustrated as an integral component of the server 102, in alternative implementations, memory 106 can be external to the server 102 and/or the meeting system 100. In some implementations, the memory 106 includes one or more persistent instances of a knowledge graph 120, a usage history 122, rules 124, and usage patterns 126.

The knowledge graph 120 can include information that identifies the uses and relationships among different types of data, including business-related data, which can be used for defining meetings and managing workflow associated with meetings. The knowledge graph 120 can be generated, stored, and/or converted from/into any suitable format or form, for example, binary, text, numerical, a database file, a flat file, or the like. In some implementations, the knowledge graph 120 can be accessed directly by any suitable component of the meeting system 100, for example, the application 107 and/or the SMS 108. In some implementations, the knowledge graph 120 may be updated regularly or at a particular time based on underlying processes and/or data/content/business objects. While the knowledge graph 120 is illustrated as an integral component of the memory 106, in alternative implementations, the knowledge graph 120 can be external to the memory 106 (e.g., stored in memory 148) and/or be separated into both external knowledge graph 120 and internal knowledge graph 120 as long as there remains accessibility using network 130.

The application 107, for example, can include a server component of a calendar application or some other application that can be used to schedule meetings such as an email application with calendar and scheduling functionality. Applications 107 can also include, or interface with, business applications, business application servers, databases, RSS feeds, document servers, web servers, streaming servers, caching servers, or other suitable content sources. The application 107 also allows the client 140 (e.g., including applications 146) to request, view, execute, create, edit, delete, and/or consume server 102 content, including information about meetings. The application 107 interfaces with the SMS 108 to use smart message capabilities in setting up meetings and managing the workflow. In some implementations, the application 107 interfaces with the SMS 108 using the API 115 and/or the service layer 116. The application 107 can be manually configured to request validation of content creation and/or other actions by calling API 115.

The SMS 108 provides core functionality for the provision of meeting information, including information for setting up a meeting, making suggestions for the meeting, and for managing a work cycle associated with the meeting. The SMS 108 includes a context search engine 109, an indexer 110, a suggestion engine 111, a rule engine 112, and workflow manager 113.

The content search engine 109, for example, can search for content that is related to the user's meeting. The searching can identify content 150 and/or content from business systems 160. For example, the related content can include documents, web pages (e.g., wikis, forums, intranet and Internet sites, etc.), business applications such as business systems, reports, and other content. In some implementations, the matching of related content can occur using semantic analysis algorithms, according to the meeting topic (e.g., based on the title and description of the meeting). The content that is identified by the content search engine 109 can be provided to the suggestion engine 111, e.g., as suggestions provided to the user as candidate content to be included with the meeting. In some implementations, providing the content can include providing a universal resource locator (URL) associated with the content so that the URL, for example, can be included in a notification of a scheduled meeting.

The indexer 110, for example, includes applications, services and/or mechanisms that analyze content to create and maintain indexes associated with content used by the system 100. Indexes can exist, for example, for content 150 and content from business systems 160. The indexes can be used, for example, by the search engine 109, such as to identify content suggestions for a meeting that is being defined.

The suggestion engine 111, for example, can suggest content that can be used in the body of the meeting announcement or included as an attachment. In some implementations, the suggestion engine 111 can include a ranking engine that ranks suggestions and selects a subset of suggestions (e.g., the highest-ranked 5-10 suggestions) to present to the user. The selection and ranking of the suggestions can be based, for example, on how well each suggestion matches the user's usage history 122, usage patterns 126, and/or other criteria. Other ways can be used to rank suggestions.

The rule engine 112 can use rules 124 in order to perform operations and facilitate making selections and suggestions related to meetings. For example, the rule engine 112 may identify the type of the meeting based on the structure of the meeting subject (e.g., project name “demo”). In this example, the rule engine 112 can use rules 124 to determine that the meeting is associated, for example, with a demo for a particular project, and further identify the specific project in a project management system. Rules 124 can also include one or more rules for specifying the recurrence pattern of meetings, e.g., determining that the meeting is weekly meeting if “weekly” appears somewhere in the topic or body of the meeting request. Other rules 124, for example, can be used to identify key participants of meetings, e.g., if certain titles (e.g., “Manager”) are associated with users who are part of a specific project or identified in some other way. Other rules 124 can be used to identify the types of locations that are selected or suggested for a meeting, e.g., to identify a meeting room having audio-visual capabilities if the meeting is associated with a demo. Other rules 124 can be used to periodically check for each of the registered or the active users invited to a meeting created under the system 100. Some rules can be used to make periodic checks. For example, at 48 and 24 hours before a meeting starts, the acceptance rate for meeting attendees, including key attendees, can be checked. If an insufficient number of key participants have confirmed attendance of the meeting, then the meeting can be canceled or messages can be sent to the attendees.

In some implementations, the rule engine 112 can be made up of multiple sub-engines. For example, there can be one or more rules sub-engines for identifying meeting types, key participants for each meeting type, meeting topics, projects associated with a topic, locations (e.g., meeting rooms) based on the type of meeting, type(s) of content that is usually required for a meeting type, and other information that can use rules-based identification.

The client 140 (e.g., clients 140a-140c) may be any computing device operable to connect to or communicate with at least the server 102 using the network 130. In general, the client 140 comprises an electronic computing device operable to receive, transmit, process, and store any appropriate data associated with the meeting system 100, for example, the application 107, GUIs, utilities/tools, and the like. The client typically includes a processor 144, a client application 146, a memory 148, and/or an interface 149.

The client application 146 is any type of application that allows the client 140 to navigate to/from, request, view, create, edit, delete, administer, and/or manipulate content associated with the server 102. In some implementations, the client application 146 can be and/or include a calendar application and or other applications through which meetings can be defined. Once a particular client application 146 is launched, a user may interactively process information associated with meetings handled by the server 102 and/or other components of the meeting system 100. For example, the client application 146 can receive, generate and transmit meeting-related information that is managed by the server 102. Further, although illustrated as a single client application 146, the client application 146 may be implemented as multiple client applications in the client 140. Further, there can be different types of client applications 146, such as different types of calendar applications that vary based on a device type and operating system of the client 140.

In some implementations, the client application 146 includes a plug-in 147, e.g., for providing client-side smart meeting capabilities. The plug-in 147, for example, can be the client-side portion of the client application 146 that communicates with the SMS 108, e.g., when a user of the client 140 sets up a meeting.

The interface 149 is used by the client 140 for communicating with other computing systems in a distributed computing system environment, including within the meeting system 100, using network 130. For example, the client 140 uses the interface to communicate with the server 102 as well as other systems (e.g., business systems 160) that can be communicably coupled to the network 130. The interface 149 may be consistent with the above-described interface 104 of the server 102 or other interfaces within the meeting system 100. The processor 144 may be consistent with the above-described processor 105 of the server 102 or other processors within the meeting system 100. Specifically, the processor 144 executes instructions and manipulates data to perform the operations of the client 140, including the functionality required to send requests to the server 102 and to receive and process responses from the server 102.

The memory 148 typically stores objects and/or data associated with the purposes of the client 140. The memory 148 may also be consistent with the above-described memory 106 of the server 102 or other memories within the meeting system 100. The memory 148 can be used to store data similar to that stored in the other memories of the meeting system 100 for purposes such as backup, caching, and the like.

Further, the illustrated client 140 includes a GUI 142 that interfaces with at least a portion of the meeting system 100 for any suitable purpose. For example, the GUI 142 may be used to view data associated with the client 140, the server 102, or any other component of the meeting system 100. In some implementations, the client application 146 may act as a GUI interface for the application 107, suggestion engine 111 of the SMS 108, other components of server 102, and/or other components of the meeting system 100 (whether illustrated or not). In the case of generating administrative requests, the GUI 142 can be used, in some implementations, to format, save, edit, and/or transmit API 115 calls to the server 102 in order to extend SMS 108 functionality and/or persistencies. For example, the server 102 user can generate JAVA (or other suitable computing language) API 115 calls to the SMS 108 to extend persistent instances of the rules 124 and/or usage patterns 126.

There may be any number of clients 140 associated with, or external to, the meeting system 100. For example, while the illustrated meeting system 100 includes one client 140 (with example configurations 140a-140c) communicably coupled to the server 102 using network 130, alternative implementations of the meeting system 100 may include any number of clients 140 suitable to the purposes of the meeting system 100. Additionally, there may also be one or more additional clients 140 external to the illustrated portion of the meeting system 100 that are capable of interacting with the meeting system 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 (example configurations illustrated as 140a-140c) is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142, as shown with respect to the client 140.

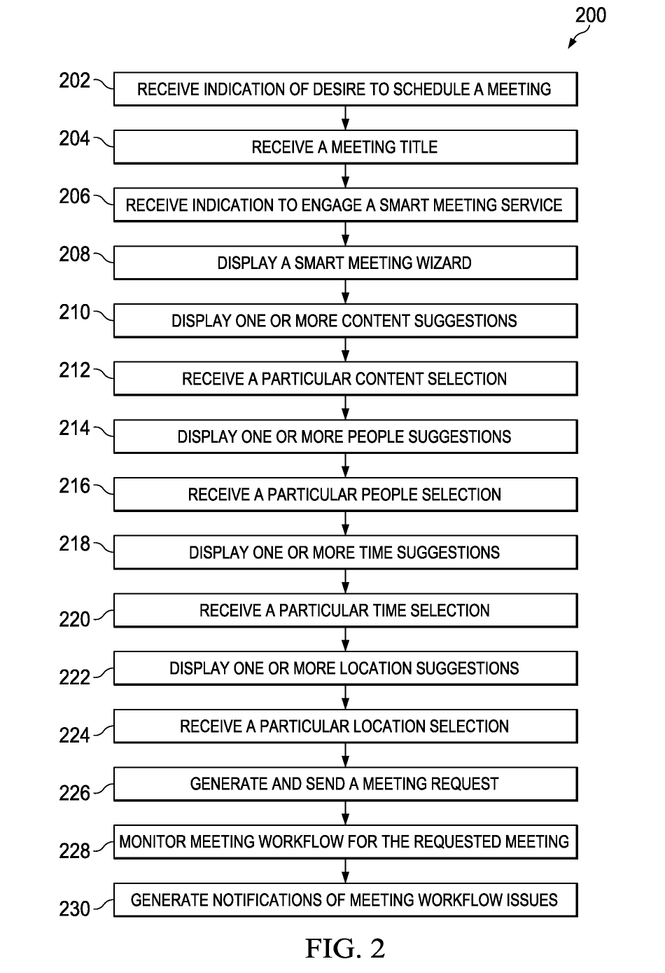

FIG. 2 is a flow chart of a method 200 for providing a smart meeting service. For clarity of presentation, the description that follows generally describes method 200 in the context of FIG. 1. However, it will be understood that method 200 may be performed, for example, by any other suitable system, environment, software, and hardware, or a combination of systems, environments, software, and hardware as appropriate. In some implementations, various steps of method 200 can be run in parallel, in combination, in loops, or in any order. Further, some steps can be optional, such as steps that initiate the display of suggestions and other steps.

At 202, an indication is received to schedule a meeting. As an example, the application 107 (e.g., a calendar application running on the server 102) can receive an input from the client 140 that the user wants to schedule a meeting. The input can be received from the client application 146 (e.g., a calendar application front end) based on inputs provided by the user in the GUI 142.

At 204, a meeting title is received, e.g., as part of the indication to schedule the meeting. For example, during a meeting request or similar operation using the client application 146, the user can provide the subject and/or title of the meeting (e.g., “Weekly Architecture Design Meeting”) that can accompany or follow a meeting request that the user enters using the GUI 142.

At 206, an indication is received to engage a smart meeting service. As an example, the client application 146 can provide an option to the user to interface with the SMS 108. The option can be selected, for example, using a control in the GUI 142. Upon selection of the option to use the smart meeting service, the client application 146 can initiate the plug-in 147 that serves as an interface to the SMS 108. The application 107 and/or the SMS 108 can receive in indication that the user has requested to engage the SMS 108.

At 208, a smart meeting wizard is presented that is responsive to receiving the indication to engage the smart meeting service. For example, the plug-in 147 can initiate a smart meeting wizard that can execute and the client and present a smart meeting interface on the GUI 142.

At 210, display is initiated of one or more content suggestions. For example, the suggestion engine 111 can generate content suggestions, such as content that the user can select from to include in an email message or other notification for the meeting. The content suggestions can be based, e.g., on content that is searched by the content search engine 109. For example, the content search engine 109 can search content 150 and/or content from business systems 160 using meeting request information received from the client 140, such as the meeting title and/or description. In some implementations, searching for content can also use information from one or more of the knowledge graph 120, usage history 122 (e.g., associated with the user), rules 124 (e.g., defining how to search for content based on provided inputs), and usage patterns 126 (e.g., associated with the user). The SMS 108 can provide the content suggestions to the client 140, e.g., using the service layer 116. Once received at the client 140, the plug-in 147, for example, can present the suggestions to the user in the GUI 142.

At 212, a particular content selection is received. For example, the service layer 116 (or the SMS 108) can receive indications as to which suggested content the user has selected. In some implementations, the indications can also identify how the content is to be presented, e.g., within the body of a meeting request email message, either in-line, as links, or as attachments.

At 214, display is initiated of one or more people suggestions. For example, the suggestion engine 111 can generate people suggestions, e.g., suggested meeting participants. The people suggestions can include, e.g., people identified by the suggestion engine 111 as past participants in similar meetings. The suggestions can also be based on analyzing people-related information from business systems 160, the knowledge graph 120, usage history 122, rules 124, and usage patterns 126. The SMS 108 can provide the people suggestions to the client 140, e.g., using the service layer 116. Once received at the client 140, the plug-in 147, for example, can present the suggestions to the user in the GUI 142.

In some implementations, initiating a display of one or more people selections further comprises determining whether at least one of the people is considered a key participant in the meeting. For example, the people suggestions identified by the suggestion engine 111 can include an identification of key participants.

At 216, a particular people selection is received. For example, the service layer 116 (or the SMS 108) can receive indications as to which suggested meeting participants the user has selected, and optionally, other meeting participants identified by the user and that were not suggested. In some implementations, the indications can also identify which, if any, of the meeting participants are key participants.

At 218, display is initiated of one or more time suggestions. For example, the suggestion engine 111 can generate suggested meeting times. The time suggestions can include, e.g., times that work best for the participants who are invited to meeting. The time suggestions can be based on information obtained from the participants' calendars and/or other participant-specific sources. In some implementations, the suggested times can be based at least in part of the scheduled work hours of the invited participants, e.g., so as not to schedule a meeting too early or too late on a business day. The SMS 108 can provide the time suggestions to the client 140, e.g., using the service layer 116. Once received at the client 140, the plug-in 147, for example, can present the suggestions to the user in the GUI 142.

At 220, a particular time selection is received. For example, the service layer 116 (or the SMS 108) can receive indications as to which suggested time(s) the user has selected.

At 222, display is initiated of one or more location suggestions. For example, the suggestion engine 111 can generate suggested meeting locations (e.g., conference rooms). The location suggestions can include, e.g., locations that work best for the participants who are invited to meeting, such as including one or more locations that are nearest the largest number of participants. The time suggestions can be based on information obtained from employee records (e.g. identifying their work location) and from facilities information (e.g., identifying the location, size and other characteristics of meeting rooms). The SMS 108 can provide the location suggestions to the client 140, e.g., using the service layer 116. Once received at the client 140, the plug-in 147, for example, can present the suggestions to the user in the GUI 142.

At 224, a particular location selection is received. For example, the service layer 116 (or the SMS 108) can receive indications as to which location (e.g., a meeting room) the user has selected.

In some implementations, at least one of the one or more content suggestions, the one or more people suggestions, the one or more time suggestions, and the one or more location suggestions are determined, at least in part, using a usage history of a user scheduling the meeting. For example, for any, some or all of the suggestions generated by the suggestion engine 113, information about past meetings organized by the meeting organizer can be accessed from the usage history 122.

At 226, a meeting request is generated and sent. For example, the SMS 108 can generate a meeting request using information provided by the user, including a combination of user-input information (e.g., meeting title and description), user-selected suggestions (e.g., content, people, time and location suggestions), and formatting added by the SMS 108. The generated meeting request can be sent by the application 107 (e.g., a calendar application server) and received by invited meeting participants, e.g., in calendar-related applications 146 running at the invitees' client devices 140.

At 228, meeting workflow is monitored for the meeting request. For example, once the meeting requests are sent, the workflow manager 113 can monitor replies (e.g., meeting acceptances and declinations) and follow up as needed, e.g., to remind invited participants to respond to the meeting request, track acceptances, and send meeting reminders. The workflow manager 113 can also follow up after the meeting with post-meeting message and scheduled follow-on meetings.

In some implementations, monitoring for the meeting request further includes determining whether an identified key person has accepted the meeting request. For example, the workflow manager 113 can track which key persons have accepted the meeting, send follow-up messages as needed, and cancel or reschedule the meeting if insufficient key people have accepted the meeting request. In some implementations, if a meeting is canceled and/or needs to be rescheduled, the SMS 108 can provide the meeting organizer with suggestions for new times and places for the meeting.

At 230, a notification associated with meeting workflow issues is generated. For example, the workflow manager 113 can automatically send notification messages to the meeting organizer and/or the meeting invitees/participants when issues arise during the meeting workflow that requires communication to relevant parties. Example, notification messages include cancelation notices, re-scheduling notices, change-of-location notices, meeting updates with additional or updated content, and other suitable messages that can occur in relation to a meeting. In some implementations, the notification can be a notification to a creator of the meeting that a particular key participant has declined or has not accepted the meeting request or that an attendance ratio for the meeting is below a predetermined threshold. For example, the person who scheduled the meeting can receive an automatic email if Key Participant A has declined the meeting (or has not yet accepted), or if the confirmed number of participants is below a certain percentage (e.g., 75%).

FIGS. 1 and 2 illustrate and describe various aspects of computer-implemented methods, computer-readable media, and computer systems for providing a smart meeting system. While the disclosure discusses the processes in terms of examples using calendar applications, the described computer-implemented methods, computer-readable media, and computer systems can also be applied in other applications. The present disclosure is not intended to be limited to the described and/or illustrated implementations related to calendar systems, but is to be accorded the widest scope consistent with the principles and features disclosed herein.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS, and/or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving a meeting title as part of an indication to schedule a meeting;
receiving an indication to engage a smart meeting service;
receiving:
a content selection;
a people selection;
a time selection; and
a location selection;
sending a generated meeting request; and
monitoring a meeting workflow for the generated meeting request.

2. The method of claim 1, further comprising initiating a presentation of a smart meeting wizard responsive to receiving the indication to engage the smart meeting service.

3. The method of claim 1, wherein monitoring the meeting workflow further comprises determining whether an identified key person has accepted the meeting request.

4. The method of claim 1, further comprising initiating display of:
one or more content suggestions;
one or more people suggestions;
one or more time suggestions; and
one or more location suggestions.

5. The method of claim 4, wherein initiating a display of one or more people suggestions further comprises determining whether at least one of the people is considered a key participant in the meeting.

6. The method of claim 4, wherein at least one of the one or more content suggestions, the one or more people suggestions, the one or more time suggestions, and the one or more location suggestions is determined, at least in part, using a usage history of a user scheduling the meeting.

7. The method of claim 1, further comprising initiating generation of a notification associated with meeting workflow issues.

8. The method of claim 7, wherein the notification is a notification to a creator of the meeting that a particular key participant has declined or has not accepted the meeting request or that an attendance ratio for the meeting is below a predetermined threshold.

9. A non-transitory, computer-readable medium storing computer-readable instructions executable by a computer and operable to:
receive a meeting title as part of an indication to schedule a meeting;
receive an indication to engage a smart meeting service;
receive:
a content selection;
a people selection;
a time selection; and
a location selection;
send a generated meeting request; and
monitor a meeting workflow for the generated meeting request

10. The computer-readable medium of claim 9, further comprising instructions operable to initiate a presentation of a smart meeting wizard responsive to receiving the indication to engage the smart meeting service.

11. The computer-readable medium of claim 9, wherein monitoring the meeting workflow further comprises determining whether an identified key person has accepted the meeting request.

12. The computer-readable medium of claim 9, further comprising instructions operable to initiate display of:
one or more content suggestions;
one or more people suggestions;
one or more time suggestions; and
one or more location suggestions.

13. The computer-readable medium of claim 12, wherein initiating a display of one or more people suggestions further comprises determining whether at least one of the people is considered a key participant in the meeting.

14. The computer-readable medium of claim 12, wherein at least one of the one or more content suggestions, the one or more people suggestions, the one or more time suggestions, and the one or more location suggestions is determined, at least in part, using a usage history of a user scheduling the meeting.

15. A system, comprising:
a memory configured to contain at least one meeting request;
a content search engine that searches for content related to a meeting request;
an indexer that indexes content associated with, and eligible to be included with, the meeting request;
a suggestion engine for generating suggestions for use in completing the meeting request;
a rule engine for executing rules associated with completing the meeting request;
a workflow manager for tracking workflow associated with the meeting request;
at least one computer interoperably coupled with the memory and configured to:
receive a meeting title as part of an indication to schedule a meeting;
receive an indication to engage a smart meeting service;
receive:
a content selection;
a people selection;
a time selection; and
a location selection;
send a generated meeting request; and
monitor a meeting workflow for the generated meeting request.

16. The system of claim 15, further configured to initiate a presentation of a smart meeting wizard responsive to receiving the indication to engage the smart meeting service.

17. The system of claim 15, wherein monitoring the meeting workflow further comprises determining whether an identified key person has accepted the meeting request.

18. The system of claim 15, further configured to initiate display of:
one or more content suggestions;
one or more people suggestions;
one or more time suggestions; and
one or more location suggestions.

19. The system of claim 18, wherein initiating a display of one or more people suggestions further comprises determining whether at least one of the people is considered a key participant in the meeting.

20. The system of claim 18, wherein at least one of the one or more content suggestions, the one or more people suggestions, the one or more time suggestions, and the one or more location suggestions is determined, at least in part, using a usage history of a user scheduling the meeting.
